(19) United States
(12) Patent Application Publication
(10) Pub. No.: US 2018/0137197 A1
(43) Pub. Date: May 17, 2018

(54) WEB PAGE METADATA CLASSIFIER

(71) Applicant: LinkedIn Corporation, Sunnyvale, CA (US)

(72) Inventors: Rachit Kumar, Bangalore (IN); Alexander R. Dalal, San Ramon, CA (US); Young Hun Choi, San Francisco, CA (US); Priyanka Gariba, Mumbai (IN)

(21) Appl. No.: 15/354,831

(22) Filed: Nov. 17, 2016

(51) Int. Cl. G06F 17/30; H04L 29/08; H04L 29/06

(52) U.S. Cl. CPC G06F 17/30864; H04L 67/02; G06F 17/30876; H04L 67/20; H04L 67/10; H04L 67/42

(57) ABSTRACT

Among other things, embodiments of the present disclosure discussed herein may be used to identify and classify new web page content based on metadata in the content. The embodiments of the present disclosure help provide a classification solution for web content that is scalable to large numbers of content attributes, has the flexibility to predict values for a wide range of diverse attributes, and provides consistent and highly accurate results.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright LinkedIn, All Rights Reserved.

### BACKGROUND

As the popularity of Internet-based content continues to grow, there is an increasing need for content hosts and providers (as well as others) to classify and categorize web page content. Among other things, categorization of web page content allows content providers to better match content to particular web page viewers and to track the popularity of different types of content.

Conventional systems for categorizing web page content typically operate on the text within a web page and may require significant amounts of text to perform the categorization. Categorizations by such systems is often inaccurate, requiring manual intervention by humans to perform corrections. Embodiments of the present disclosure, by contrast, can (among other things) categorize web page content based on small amounts of text, and provides consistent and highly-accurate categorizations of new content based on patterns in the metadata of the web content.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram illustrating a client-server system, according to various exemplary embodiments;

FIG. 2A is a flow diagram of a method according to various exemplary embodiments.

FIGS. 2B-2C are screenshots of web page content according to various exemplary embodiments.

FIGS. 2D-2T are tables showing the classification of web content according to various exemplary embodiments.

FIG. 3 is a block diagram illustrating an exemplary mobile device.

FIG. 4 is a block diagram illustrating components of an exemplary computer system.

### DETAILED DESCRIPTION

In the following, a detailed description of examples will be given with references to the drawings. It should be understood that various modifications to the examples may be made. In particular, elements of one example may be combined and used in other examples to form new examples. Many of the examples described herein are provided in the context of a social or business networking website or service. However, the applicability of the embodiments in the present disclosure are not limited to a social or business networking service.

Among other things, embodiments of the present disclosure discussed herein may be used to identify and classify new web page content based on metadata in the content. The embodiments of the present disclosure help provide a classification solution for web content that is scalable to large numbers of content attributes, has the flexibility to predict values for a wide range of diverse attributes, and provides consistent and highly accurate results.

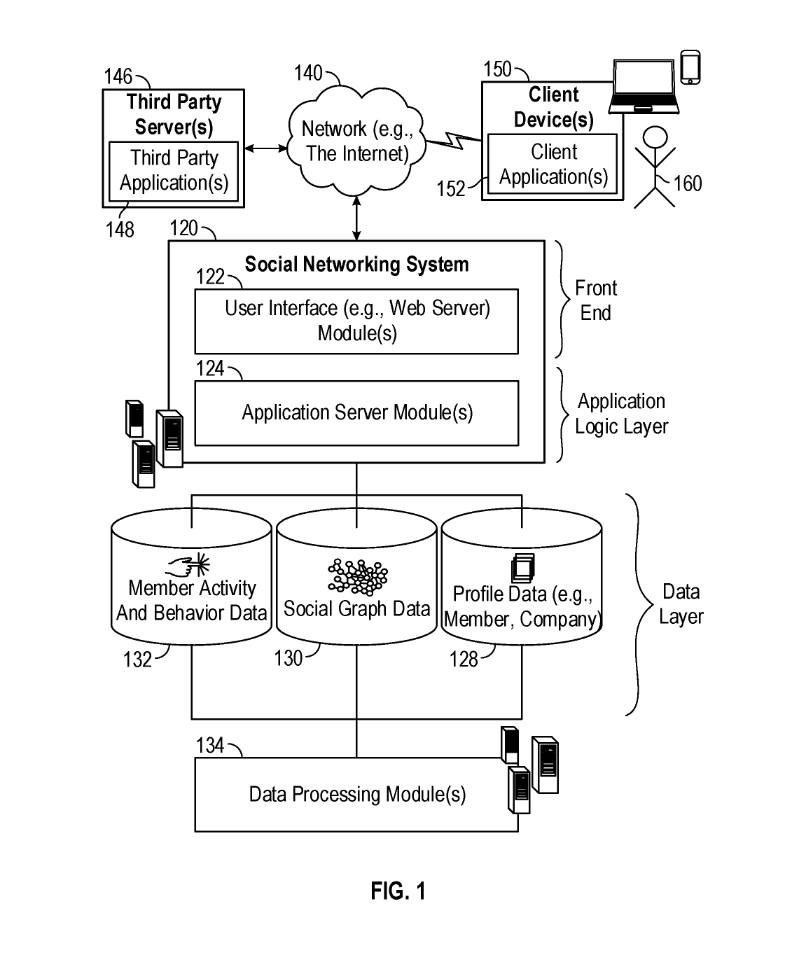

FIG. 1 illustrates an exemplary client-server system that may be used in conjunction with various embodiments of the present disclosure. The social networking system 120 may be based on a three-tiered architecture, including (for example) a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. Various additional functional modules and engines may be used with the social networking system illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the embodiments of the present disclosure are not limited to such architecture.

An Internet-based social networking service is a web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information.

For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes may be referred to as “business networks” or “professional networks”).

Online social network platforms (also referred to herein as Internet-based social networks) provide a variety of information and content to users of the social network, such as articles on various topics, updates related to a user and individuals within the user's network, job opportunities, friend (or connection) suggestions, advertisements, news stories, and the like.

As shown in FIG. 1, the front end layer consists of a user interface module(s) (e.g., a web server) 122, which receives content requests from various computing devices including one or more user computing device(s) 150, and communicates appropriate responses to the requesting device. For example, the user interface module(s) 122 may receive requests in the form of Hypertext Transport Protocol (HTTP) requests, or other web-based, application programming interface (API) requests. The user device(s) 150 may be executing conventional web browser applications and/or applications (also referred to as “apps”) that have been developed for a specific platform to include any of a wide variety of mobile computing devices and mobile-specific operating systems.

For example, user device(s) 150 may be executing user application(s) 152. The user application(s) 152 may provide functionality to present information to the user and communicate via the network 140 to exchange information with the social networking system 120. Each of the user devices 150 may comprise a computing device that includes at least a display and communication capabilities with the network 140 to access the social networking system 120. The user devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other entity interacting with the client device(s) 150. The user(s) 160 may interact with the social networking system 120 via the user device(s) 150. The user(s) 160 may not necessarily be part of the networked environment, but may be associated with user device(s) 150.

For example, the user 160 may, using the user's client device 150, submit a request for web page content (e.g., by entering or selecting a web page address via a web browser) hosted by a third party server 146 and/or social networking system 120. The server 146 and/or social networking system 120 may, in response to the request, cause web page content to display on a display screen coupled to the client device 150, and to classify the web content as described in more detail below.

As shown in FIG. 1, the data layer includes several databases, including a database 128 for storing data for various entities of a social graph. In some exemplary embodiments, a “social graph” is a mechanism used by an online social networking service (e.g., provided by the social networking system 120) for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. With various alternative embodiments, any number of other entities may be included in the social graph, and as such, various other databases may be used to store data corresponding to other entities. For example, the data layer may include one or more databases for storing webpage metadata.

In some embodiments, when a user initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the social networking service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some exemplary embodiments, members may receive advertising targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For instance, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124.

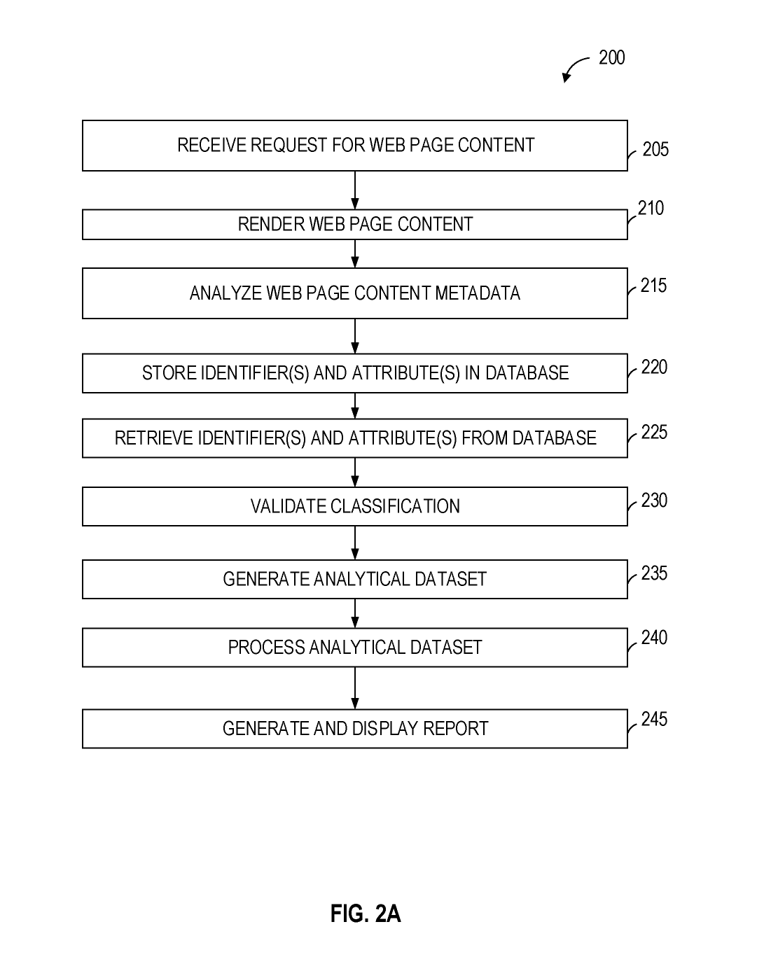

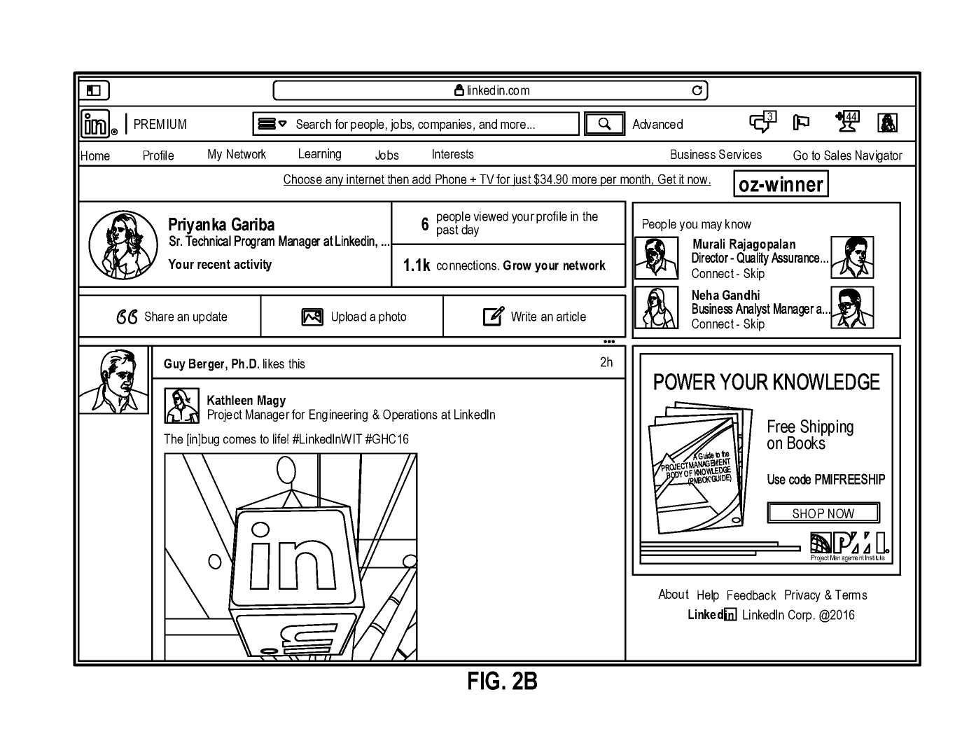

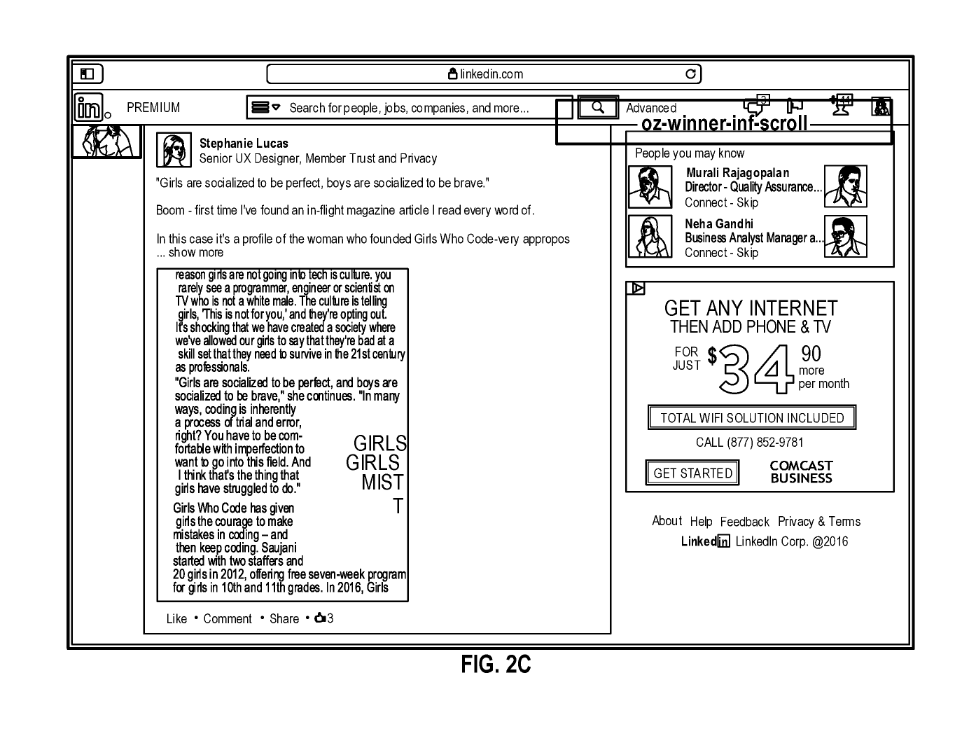

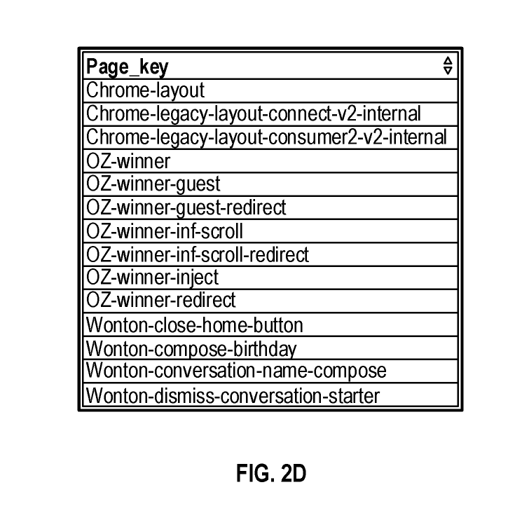

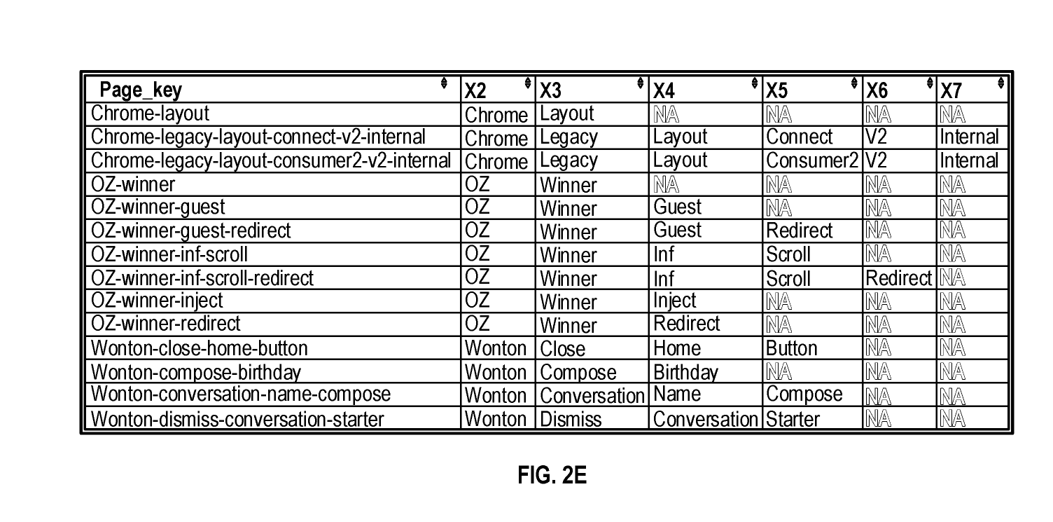

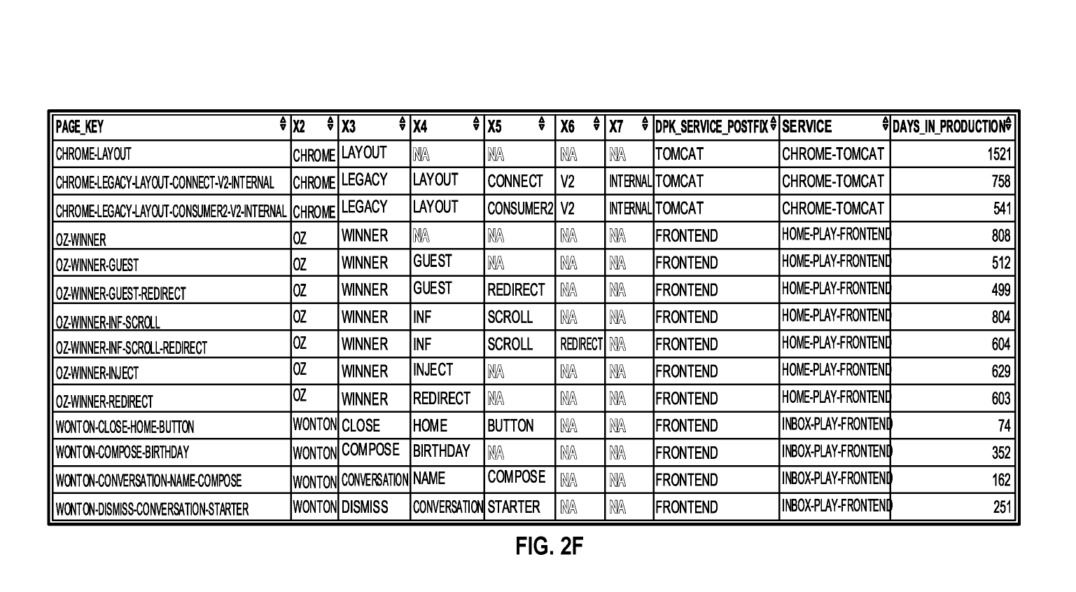

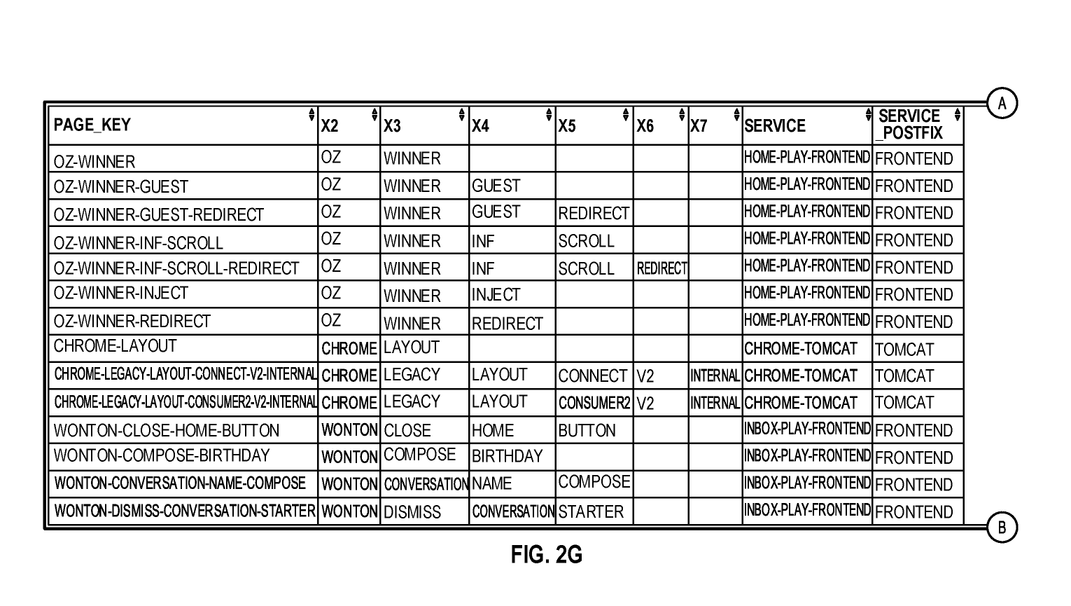

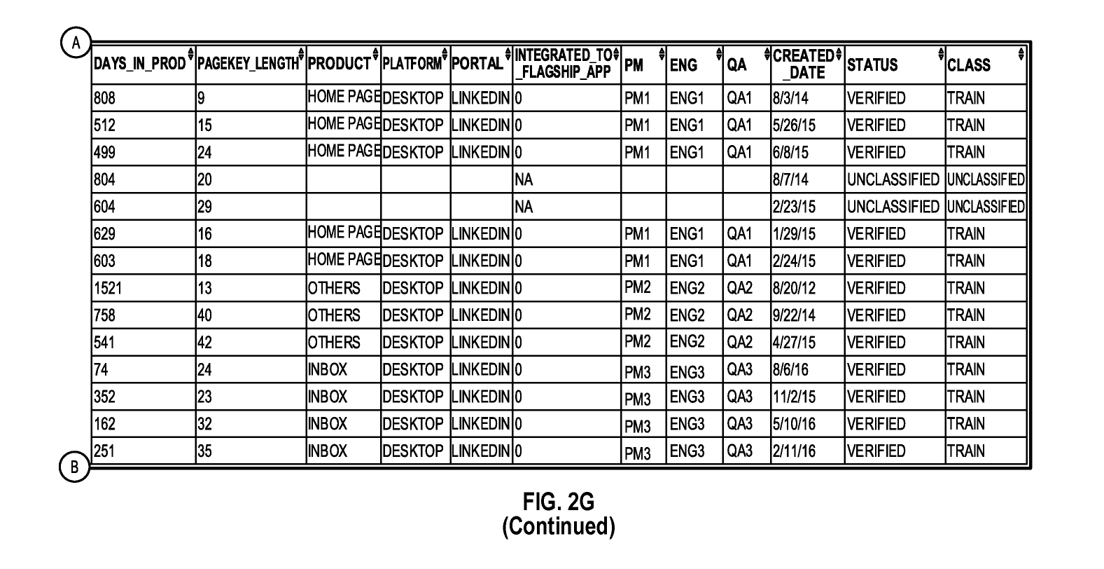

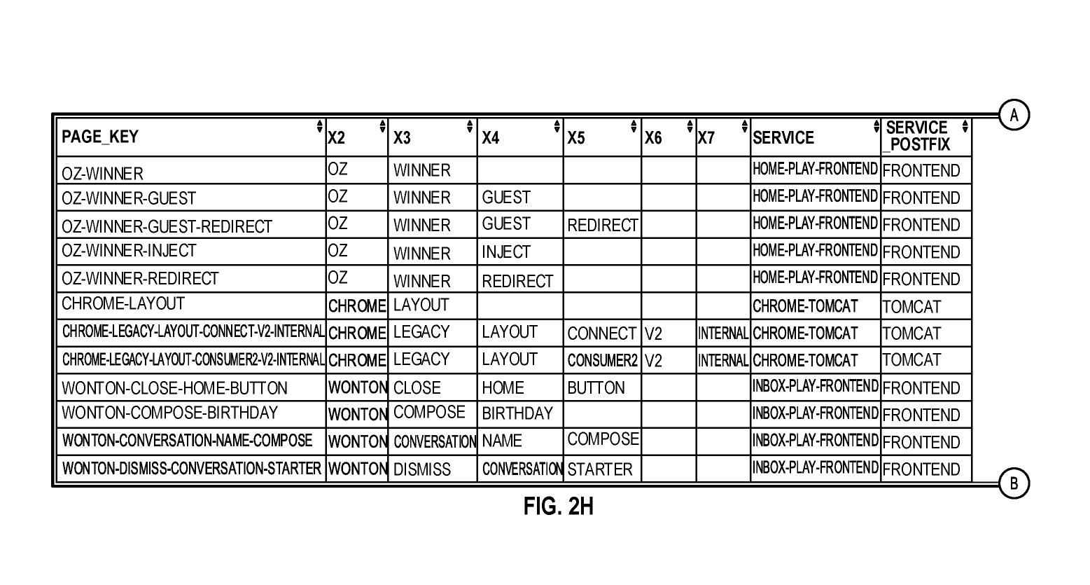

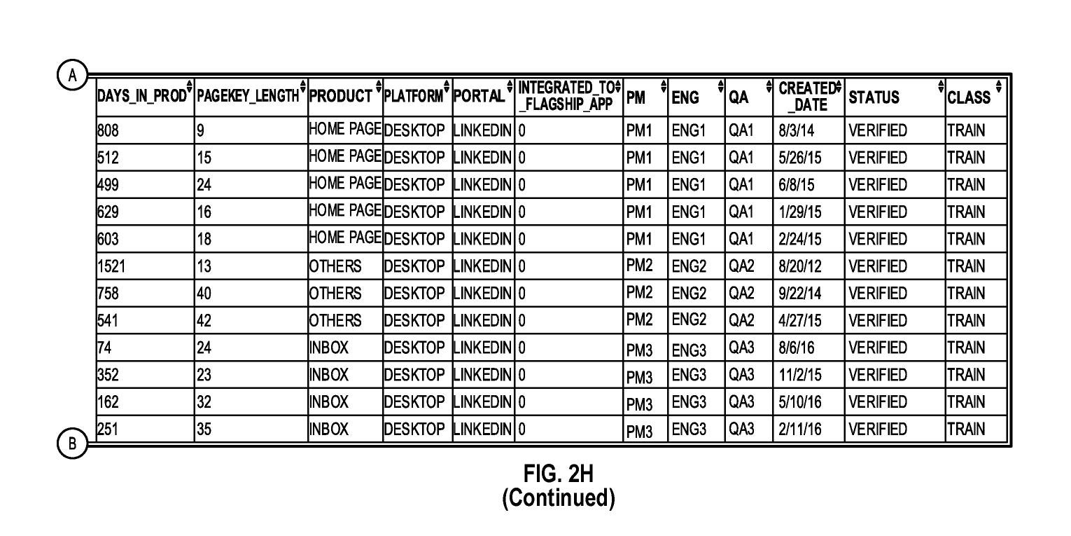

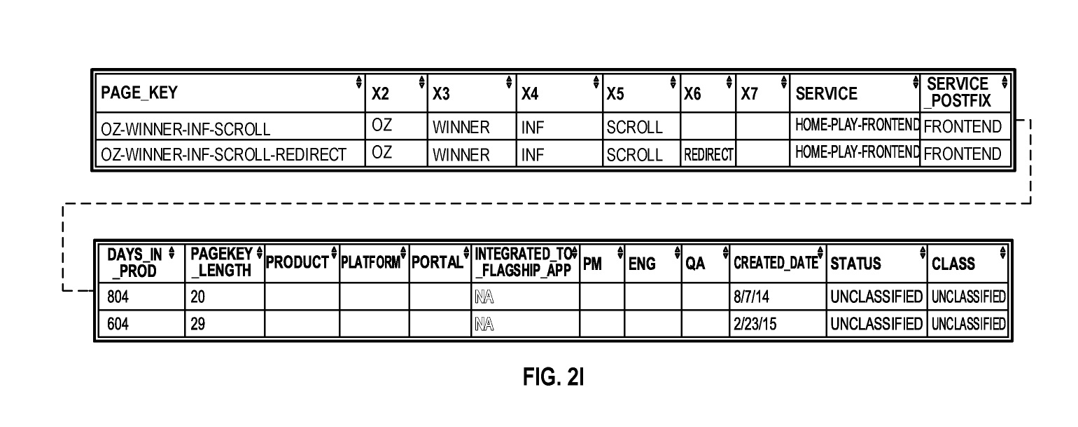

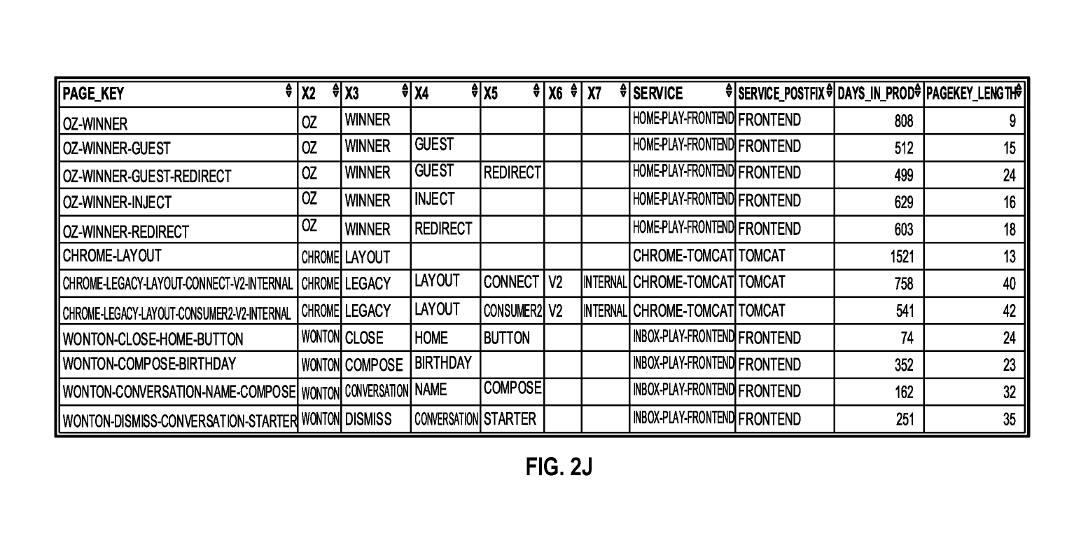

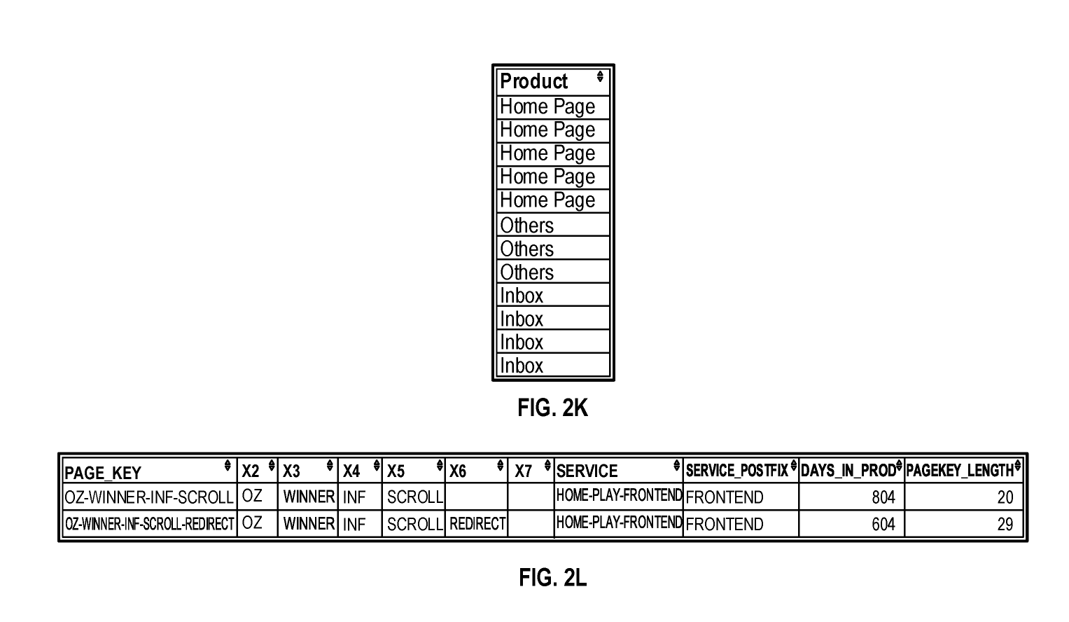

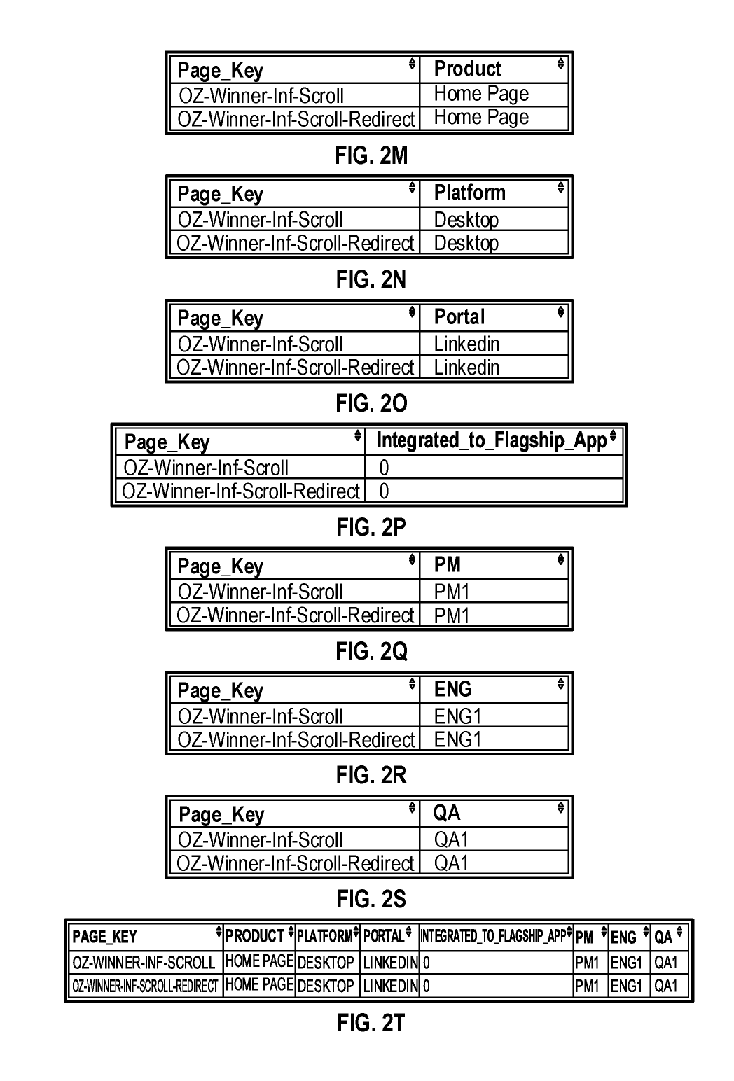

Further, as shown in FIG. 1, a data processing module 134 may be used with a variety of applications, services, and features of the social networking system 120. The data processing module 134 may periodically access one or more of the databases 128, 130, and/or 132, process (e.g., execute batch process jobs to analyze or mine) profile data, social graph data, member activity and behavior data, and generate analysis results based on the analysis of the respective data. The data processing module 134 may operate offline. According to some exemplary embodiments, the data processing module 134 operates as part of the social networking system 120. Consistent with other exemplary embodiments, the data processing module 134 operates in a separate system external to the social networking system 120. In some exemplary embodiments, the data processing module 134 may include multiple servers of a large-scale distributed storage and processing framework, such as Hadoop servers, for processing large data sets. The data processing module 134 may process data in real time, according to a schedule, automatically, or on demand. In some embodiments, the data processing module 134 may perform (alone or in conjunction with other components or systems) the functionality of method 200 depicted in FIG. 2 and described in more detail below.

Additionally, a third party application(s) 148, executing on a third party server(s) 146, is shown as being communicatively coupled to the social networking system 120 and the user device(s) 150. The third party server(s) 146 may support one or more features or functions on a website hosted by the third party.

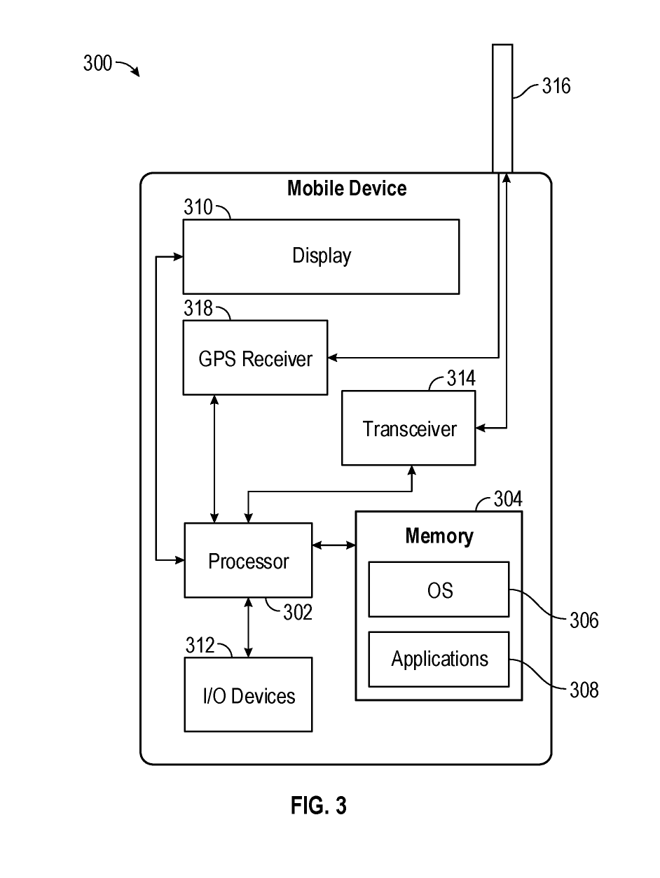

FIG. 2 illustrates an exemplary method 200 for classifying web page content according to various aspects of the present disclosure. Embodiments of the present disclosure may practice the steps of method 200 in whole or in part, and in conjunction with any other desired systems and methods. The functionality of method 200 may be performed, for example, using any combination of the systems depicted in FIGS. 1, 3, and/or 4.

In this example, method 200 includes receiving a request for web page content (205), rendering web page content (210), analyzing metadata in the web page content to determine one or more identifiers and classifier attributes (215), and storing the identifier(s) and classifier attribute(s) in a database (220). Method 200 further includes retrieving one or more identifiers and classifier attributes from the database (225), validating classification of one or more identifiers (230), generating (235) and processing (240) an analytical dataset, and generating and displaying a report (245).

Embodiments of the present disclosure may receive a request for web page content (205) in a variety of different ways. For example, referring to FIG. 1, a user 160 may transmit (using the user's client computing device 150) the request over the Internet or other network 140 to social networking system 120. The request may be generated using, for example, a web browser operating on the client computing device 150. As an example, the request may be generated in conjunction with the user accessing a web page (such as the user's home page) on the online social network.

The request for content (205) may be included in any number of different electronic communications. In this context, an “electronic communication” may include any electronic transmission of data, including data exchanged via an application programming interface (API) exposed by the social network system 120, client devices 150, and/or other devices. In some embodiments, an electronic communication may include, for example: a mobile push notification, a text message, an email, an Internet Relay Chat (IRC) message, an API call, transmission of a data packet (e.g., encrypted), information displayed and/or entered via a web interface, as well as any other suitable form of electronic communication. Electronic communications used by embodiments of the present disclosure may be transmitted over the Internet or another network 140 and may be in any format and use any type of communication protocol.

In method 200, the system renders web page content (210) on display screen coupled to the requesting device. In FIG. 1, for example, a user 160 may request web page content via a web browser operating on the user's computing device 150 and, in response to the request, the system causes the web page content to render within the web browser on the display screen of the computing device 150.

The system analyzes metadata (215) in the web page content to determine one or more unique identifiers associated with the web page content, as well as one or more classifier attributes associated with each unique identifier. The system may also utilize the web page content itself (e.g., text, images, video, etc.) in addition to the metadata to determine unique identifiers and classifier attributes. In this context, the term “metadata” refers to any data or information describing the web page content. In many web pages, for example, meta data tags are included in the underlying hypertext transfer protocol (HTML) tags of the content. In many cases, metadata is not visible to viewers of the web content, rather the metadata describes characteristics and attributes of the content itself.

The unique identifier determined by the analysis of the metadata may be in any desired format, such as an alpha-numeric string, an image, a video, and/or an icon. In some exemplary embodiments, the unique identifier is a text string derived from the metadata of the web page content. FIG. 2D illustrates a list of exemplary unique identifiers, which may be referred to herein as “page keys.” The unique identifier may include multiple components to convey information about the web page content. As shown in FIG. 2E, for example, each unique identifier (page key) is split into unique words forming a string which are separated by special characters or space. For example, “oz-winner” is split into “oz” and “winner”. Among other things, this allows the system to more specifically classify web content.

Embodiments of the present disclosure may operate in conjunction with a variety of different types of metadata. In some embodiments, for example, the system identifies a plurality of classifier attributes associated with each unique identifier. With respect to the “home page” web content displayed in FIG. 2B, for example, the system may determine multiple classifier attributes associated with the unique identifier (page key) “oz-winner” for classifying the web page content. The classifier attributes associated with the exemplary list of unique identifiers in FIG. 2D are shown in FIGS. 2F and 2G. Such attributes may include, for example, a portal identifier (e.g., the web portal associated with the web content), a platform identifier (e.g., the type of platform being used by the user to access the web content), a mobile application identifier (e.g., identifying whether the web content is specially coded for mobile devices), an organizational identifier (e.g., identifying product management, engineering, quality assurance, and other individuals or groups associated with producing the content), and other identifiers. In FIG. 2G, for instance, the classifier attributes for each unique identifier/page key include information on services associated with the web content, the length of each page key, the date the web page content was created and the number of days it has been in production, and classification information for each identifier (e.g., whether the identifier unclassified or verified).

As used herein, the term “web page content” includes any content or group of content objects displayable on a web page or via a web interface. FIGS. 2B and 2C illustrate examples of such web content. In the first example, a user requests web page content by entering “www.linkedin.com” in the user's web browser and the system displays the Linkedin homepage shown in FIG. 2B via the user's web browser. FIG. 2C illustrates a second example of web page content that displays when the user scrolls down on the homepage (FIG. 2B) until he/she has viewed content for the past 3 months. Note that the “oz-winner” tag on FIG. 2B and the “oz-winner-inf-scroll” tag on FIG. 2C are simply depicted for discussion purposes below, they are not visible on the actual web page. In some exemplary embodiments, the page key may be included in a metadata tag for the web content. In other exemplary embodiments, the page key may be derived from the metadata associated with the web content.

In cases where web content is unclassified (e.g., it is the first time it is being presented to a user) the system may analyze the metadata to determine values for the attributes associated with a web page content identifier based on one or more previously-classified identifiers for other web page content. For example, consider an example where the “homepage” web page content shown in FIG. 2B has already been classified by the system and the following classifier attributes associated with the “oz-winner” page key identifier are assigned values as follows: Product—Homepage; Portal—Linkedin; Platform—Desktop; Mobile app integration—No; project manager (PM) name—PM1; engineer (ENG) name—ENG1; quality assurance (QA) name—QA1. In this case, the system may retrieve the “oz-winner” page key identifier and associated classifier attributes from a database in communication with the system without having to determine the classifier attribute values from scratch.

If the user then scrolls down on the home page, the web content shown in FIG. 2C (associated with the “oz-winner-inf-scroll” page key identifier) displays and the system analyzes this content to identify the page key and associated attributes. In this case, consider that the “oz-winner-inf-scroll” page key does not already exist in the database, and the associated classifier attributes are not yet determined. In such a case, the system may determine classifier attributes (and values for such attributes) based on the classifier attributes associated with a previously-classified identifier (such as “oz-winner”).

Continuing this example, a new page key called “oz-winner-inf-scroll” is determined and initially registered in an ‘Unclassified’ state with all attributes set to NULL (or another unset state). The system analyzes the classifier attributes associated with the “oz-winner” page key (along with classifier attributes associated with other existing page keys) and classifies the “oz-winner-inf-scroll” page key classifier attributes (initially set to NULL) as follows: Product—NULL→Homepage; Portal—NULL→Linkedin; Platform—NULL→Desktop; Mobile app integration—NULL→No; PM name—NULL→PM1; ENG name—NULL→ENG1; QA name—NULL→QA1.

While some embodiments of the present disclosure may classify web page content in real-time or near-real-time, the system may alternatively (or additionally) batch process web content in an offline (i.e., non-real-time) manner. For example, the classification process may be run on a set of new pieces of web page content periodically (e.g., once a day) to classify the content for subsequent requests for the content.

The system stores (220) identifiers and their associated classifier attributes in a database for later retrieval (225) in response to subsequent requests for web content associated with the stored identifiers. Using the examples above, the system stores the “oz-winner” page key and associated classifier attributes in conjunction with rendering the home page content in FIG. 2B and stores the “oz-winner-inf-scroll” page key and its associated attributes in conjunction with rendering the content in FIG. 2C as the user scrolls down the homepage.

Accordingly, the “oz-winner-inf-scroll” identifier and associated classifier attributes may be determined in response to a first request for the content in FIG. 2C and the identifier and attributes stored in a database. In subsequent sessions, where a second request is made for the scrolled content in FIG. 2C, the system retrieves the identifier and associated classifier attributes for the web content from the database.

The system validates (230) the classifier of unique identifiers added to the system in conjunction with new web content based on the classifier attribute(s) associated with each unique identifier. Validation of the unique identifiers may be performed in a variety of different ways by the embodiments of the present disclosure. In some exemplary embodiments, the system can generate an analytical dataset (235) and process the analytical dataset (240) to determine/predict values for classifier attributes associated with unclassified identifiers. Embodiments of the present disclosure may perform a variety of steps in processing (240) the dataset, including splitting the analytical dataset into training and “to-be-classified” datasets, learning classification patterns from the training dataset, applying patterns on “to-be-classified” dataset, generating metadata classification, and updating the metadata classification, as described in more detail below.

In this manner, the system can automatically and accurately predict values for unclassified attributes based on the previously-classified attributes in the database.

FIGS. 2G-2I illustrate the generation of an analytical dataset using the exemplary page key identifiers discussed above. FIG. 2G includes an exemplary analytical dataset for the classifier attributes for the unique page key identifiers depicted in FIG. 2D. The analytical dataset includes a training dataset (FIG. 2H) which includes a set of classified unique page key identifiers and associated classifier attributes associated, namely page keys which have been previously verified by the system or assigned a valid status. The analytical dataset further includes a set of unclassified unique page key identifiers and associated attributes that have not been verified or validated.

In some embodiments, the verification and validation of an identifier of a piece of web content is handled automatically by the system, and may be performed according to any desired standards. In one example, “validation” of the content means the content has been properly classified with permissible attribute values and has been assigned to correct owners (e.g., via the organizational attributes). The “verification” of content, by comparison, indicates the content is not only valid, but the values of the classifier attributes are also determined to be accurate. Continuing this example, “unclassified” content is content having at least a predetermined number of page views by members, and at least one of the attributes are not classified, or at least one of the owners (e.g., “PM,” “ENG,” or “QA” in the organizational attributes) are unassigned.

The system processes (240) the analytical dataset to determine values for each unclassified attribute. In some exemplary embodiments, the system runs a separate model for each unclassified attribute. In other exemplary embodiments, multiple unclassified attributes may be determined in the same model. Some exemplary embodiments further utilize a random forest model to predict the respective values for each respective unclassified attribute associated with the unclassified unique identifiers.

Utilization of the random forest model by embodiments of the present disclosure helps provide a number of advantages. First, the tree based algorithm suits huge number of categories in independent and dependent (target) variables. Second, the random forest model helps to accurately predict the most likely label (for target variables) in the cases where a new category appears as a predictor (independent variable). Third, the random forest model can be implemented in a parallel processing manner, thus helping to provide faster training of the models. Furthermore, the random forest model has minimal bias and overfitting when implemented with large numbers (e.g., thousands) of trees used in the algorithm.

Consider an example where the classifier attribute “product” is processed, the attributes from the training (classified) data set (shown in FIG. 2J) are provided to the random forest model, where “PAGE_KEY” is the unique identifier for each respective page key and rest of the variables in FIG. 2J are treated as independent variables or “predictive features.” The target feature (“product” in this example) is also fed into the model as a “target variable” as shown in FIG. 2K.

The random forest classifier model learns association rules between the predictive features and labeled data (product labels). Each learned model (R-object) is passed to a scoring job, which uses same set of predictive features of the unclassified dataset, applies learned “association rules” and predicts values for each respective unclassified attribute based on the classified classifier attributes in the training data set portion of the analytical data set.

Continuing with the processing of the “product” attributes from above, the attributes depicted in FIG. 2L are supplied to the scoring job along with the R-object containing the association rules. The output of the scoring job for the “product” attribute is shown in FIG. 2M. Similarly, the predicted values for the other attributes are shown in FIG. 2N (Platform), FIG. 2O (Portal), FIG. 2P (integrated to flagship application flag), FIG. 2Q (PM owner), FIG. 2R (ENG owner), and FIG. 2S (QA owner). The output from each separate model may then be merged together, as shown in FIG. 2T, to provide a consolidated output.

In some embodiments, the system can generate and display a report (245) containing one or more unique identifiers and associated classifier attributes. The system may either transmit the report to the computing device of the user or another entity, or control the computing device of the user or other entity to display the report (e.g., by rendering the content of the report on the display screen of the computing device over the Internet).

Embodiments of the present disclosure may utilize a combination of different hardware and software components to implement the functionality of the embodiments described herein. For example, the social networking system 120 may include (or interface with) one or more authorization servers that that expose application program interfaces (APIs), such as HTTP REST APIs, for managing authorizations, including creating new authorization requests, updating the status of authorization requests, retrieving the details of authorization requests, etc. The authorization server(s) may interact one or more databases (e.g., databases 128, 130, 132) to read and write data regarding authorizations such as data regarding the requester (e.g., a service provider), the owner (e.g., a customer), the object of the authorization (e.g., what is authorized), the state of the authorization, the expiration time period for an authorization, and any actions that have been taken regarding the authorization (creation, updates, state change, etc.), including when and by whom.

The social networking system 120 may also include (or interface with) one or more frontend servers which render user-interfacing pages to service providers and customers on web browsers of their respective computing devices. These pages may include, for example: (1) a page for a service provider to initiate an authorization request; (2) a page for customers to give authorization/consent for the provider to perform the service; and/or (3) an authorization dashboard page for customers and service providers to view the list of incoming and outgoing authorizations and act on them. The frontend servers may call the APIs exposed by the authorization servers for filling the content of the pages rendered, and for updating persisted data when actions are taken by users.

The social networking system may further include (or interface with) one or more notification servers that handle the generation of notifications and electronic communications on multiple channels based on recipients' preferences, and pushes them out. The notification servers may utilize, or operate in conjunction with, a variety of communication technologies, including SMTP servers, the APPLE PUSH NOTIFICATION SERVICE, GOOGLE CLOUD MESSAGING SYSTEM, and other communication formats and protocols.

FIG. 3 is a block diagram illustrating a mobile device 300, according to an exemplary embodiment. The mobile device 300 may be (or include) a client device 150 (in FIG. 1) or any other device operating in conjunction with embodiments of the present disclosure. The mobile device 300 may include a processor 302. The processor 302 may be any of a variety of different types of commercially available processors 302 suitable for mobile devices 300 (for example, an XScale architecture microprocessor, a microprocessor without interlocked pipeline stages (MIPS) architecture processor, or another type of processor 302). A memory 304, such as a random access memory (RAM), a flash memory, or other type of memory, is typically accessible to the processor 302. The memory 304 may be adapted to store an operating system (OS) 306, as well as application programs 308, such as a mobile location enabled application that may provide LBSs to a user. The processor 302 may be coupled, either directly or via appropriate intermediary hardware, to a display 310 and to one or more input/output (I/O) devices 312, such as a keypad, a touch panel sensor, a microphone, and the like. Similarly, in some embodiments, the processor 302 may be coupled to a transceiver 314 that interfaces with an antenna 316. The transceiver 314 may be configured to both transmit and receive cellular network signals, wireless data signals, or other types of signals via the antenna 316, depending on the nature of the mobile device 300. Further, in some configurations, a GPS receiver 318 may also make use of the antenna 316 to receive GPS signals.

Certain embodiments may be described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In exemplary embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some exemplary embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

Exemplary embodiments may be implemented in digital electronic circuitry, or in computer hardware, firmware, software, or in combinations of them. Exemplary embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In exemplary embodiments, operations may be performed by one or more programmable processors executing a computer program to perform functions by operating on input data and generating output. Method operations can also be performed by, and apparatus of exemplary embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

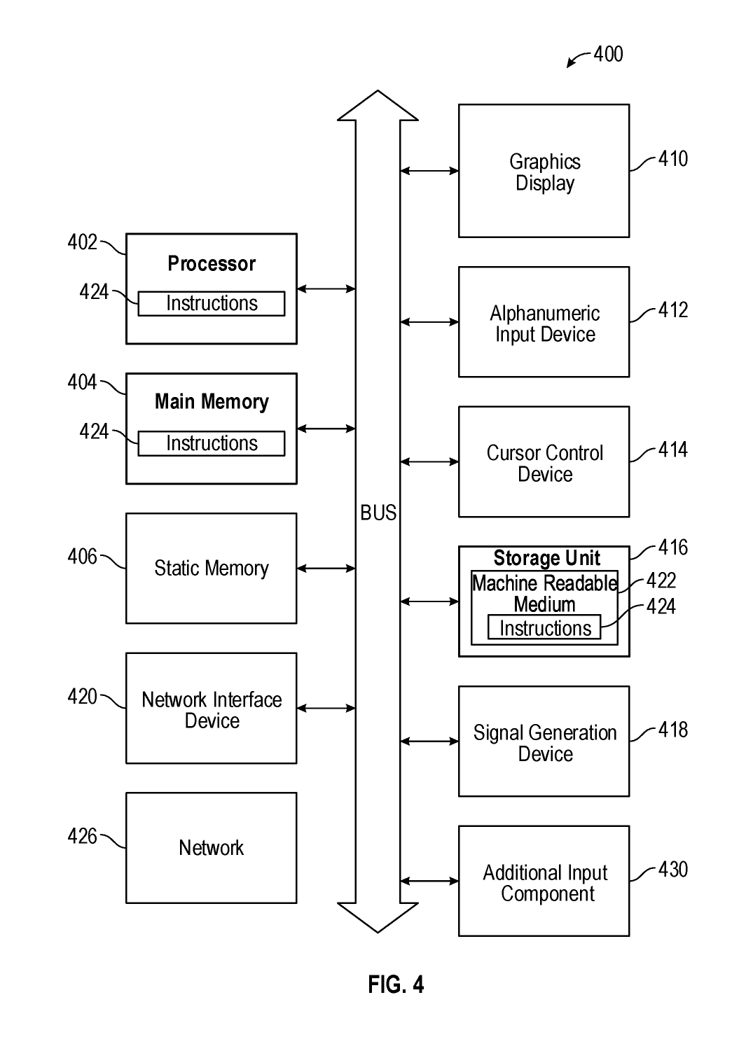

FIG. 4 is a block diagram illustrating components of a machine 400, according to some exemplary embodiments, able to read instructions 424 from a machine-readable medium 422 (e.g., a non-transitory machine-readable medium, a machine-readable storage medium, a computer-readable storage medium, or any suitable combination thereof) and perform any one or more of the methodologies discussed herein, in whole or in part. Specifically, FIG. 4 shows the machine 400 in the example form of a computer system within which the instructions 424 (e.g., software, a program, an application, an applet, or other executable code) for causing the machine 400 to perform any one or more of the methodologies discussed herein may be executed, in whole or in part.

In alternative embodiments, the machine 400 operates as a standalone device or may be connected (e.g., networked) to other machines. In a networked deployment, the machine 400 may operate in the capacity of a server machine or a client machine in a server-client network environment, or as a peer machine in a distributed (e.g., peer-to-peer) network environment. The machine 400 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 424, sequentially or otherwise, that specify actions to be taken by that machine. Further, while only a single machine is illustrated, the term “machine” shall also be taken to include any collection of machines that individually or jointly execute the instructions 424 to perform all or part of any one or more of the methodologies discussed herein.

The machine 400 includes a processor 402 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 404, and a static memory 406, which are configured to communicate with each other via a bus 408. The processor 402 may contain microcircuits that are configurable, temporarily or permanently, by some or all of the instructions 424 such that the processor 402 is configurable to perform any one or more of the methodologies described herein, in whole or in part. For example, a set of one or more microcircuits of the processor 402 may be configurable to execute one or more modules (e.g., software modules) described herein.

The machine 400 may further include a graphics display 410 (e.g., a plasma display panel (PDP), a light emitting diode (LED) display, a liquid crystal display (LCD), a projector, a cathode ray tube (CRT), or any other display capable of displaying graphics or video). The machine 400 may also include an alphanumeric input device 412 (e.g., a keyboard or keypad), a cursor control device 414 (e.g., a mouse, a touchpad, a trackball, a joystick, a motion sensor, an eye tracking device, or other pointing instrument), a storage unit 416, an audio generation device 418 (e.g., a sound card, an amplifier, a speaker, a headphone jack, or any suitable combination thereof), and a network interface device 420.

The storage unit 416 includes the machine-readable medium 422 (e.g., a tangible and non-transitory machine-readable storage medium) on which are stored the instructions 424 embodying any one or more of the methodologies or functions described herein. The instructions 424 may also reside, completely or at least partially, within the main memory 404, within the processor 402 (e.g., within the processor's cache memory), or both, before or during execution thereof by the machine 400. Accordingly, the main memory 404 and the processor 402 may be considered machine-readable media (e.g., tangible and non-transitory machine-readable media). The instructions 424 may be transmitted or received over the network 426 via the network interface device 420. For example, the network interface device 420 may communicate the instructions 424 using any one or more transfer protocols (e.g., hypertext transfer protocol (HTTP)).

In some exemplary embodiments, the machine 400 may be a portable computing device, such as a smart phone or tablet computer, and have one or more additional input components 430 (e.g., sensors or gauges). Examples of such input components 430 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 422 is shown in an exemplary embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 424 for execution by the machine 400, such that the instructions 424, when executed by one or more processors of the machine 400 (e.g., processor 402), cause the machine 400 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various exemplary embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

What is claimed is:

1. A method comprising:
receiving, over the Internet by a server computer system, a request for web page content from a client computing device of a user;
in response to the request for web page content, causing, by the server computer system, the web page content to render on a display screen coupled to the client computing device;
analyzing, by the server computer system, metadata in the web page content to determine:
a unique identifier associated with the web page content; and
a classifier attribute associated with the unique identifier for classifying the web page content, wherein determining the classifier attribute for the unique identifier is based on a classifier attribute associated with a previously-classified unique identifier for other web page content; and
storing the unique identifier and the determined classifier attribute for the web page content in a database in communication with the server computer system.

2. The method of claim 1, wherein the server computer system determines a plurality of classifier attributes associated with the unique identifier based on the metadata in the web page content.

3. The method of claim 2, wherein the plurality of classifier attributes include one or more of: a product identifier, a portal identifier, a platform identifier, a mobile application identifier, and an organizational identifier.

4. The method of claim 1, further comprising:
receiving a second request, by the server computer system over the Internet, for the web page content;
in response to the second request, retrieving the unique identifier and the determined classifier attribute for the web page content from the database by the server computer system; and
validating classification of the retrieved unique identifier, based on the determined classifier attribute, by the server computer system.

5. The method of claim 1, further comprising generating, by the server computer system, an analytical dataset based on a plurality of unique identifiers stored in the database.

6. The method of claim 5, wherein the analytical dataset comprises:
a set of classified unique identifiers and associated classified classifier attributes; and
a set of unclassified unique identifiers and associated unclassified classifier attributes.

7. The method of claim 6, further comprising processing the analytical dataset using a random forest model to predict a respective value for each respective unclassified classifier attribute associated with the set of unclassified unique identifiers.

8. The method of claim 7, wherein the respective value for each respective unclassified classifier attribute is based on classified classifier attribute values in the analytical dataset.

9. The method of claim 7, wherein a separate random forest model is run for each respective unclassified classifier attribute.

10. The method of claim 1, further comprising:
generating, by the server computer system, a report including the unique identifier and the classifier attribute; and
causing, by the server computer system, the report to display on the display screen coupled to the client computing device.

11. A system comprising:
a processor; and
memory coupled to the processor and storing instructions that, when executed by the processor, cause the system to perform operations comprising:
receiving, over the Internet, a request for web page content from a client computing device of a user;
in response to the request for web page content, causing, by the system, the web page content to render on a display screen coupled to the client computing device;
analyzing metadata in the web page content to determine:
a unique identifier associated with the web page content; and
a classifier attribute associated with the unique identifier for classifying the web page content, wherein determining the classifier attribute for the unique identifier is based on a classifier attribute associated with a previously-classified unique identifier for other web page content; and
storing the unique identifier and the determined classifier attribute for the web page content in a database in communication with the system.

12. The system of claim 11, wherein the system determines a plurality of classifier attributes associated with the unique identifier based on the metadata in the web page content.

13. The system of claim 12, wherein the plurality of classifier attributes include one or more of: a product identifier, a portal identifier, a platform identifier, a mobile application identifier, and an organizational identifier.

14. The system of claim 11, wherein the memory further comprises instructions for causing the system to perform operations comprising:
receiving a second request, over the Internet, for the web page content;
in response to the second request, retrieving the unique identifier and the determined classifier attribute for the web page content from the; and
validating classification of the retrieved unique identifier, based on the determined classifier attribute.

15. The system of claim 11, wherein the memory further comprises instructions for causing the system to perform operations comprising: generating an analytical dataset based on a plurality of unique identifiers stored in the database.

16. The system of claim 15, wherein the analytical dataset comprises:
a set of classified unique identifiers and associated classified classifier attributes; and
a set of unclassified unique identifiers and associated unclassified classifier attributes.

17. The system of claim 16, wherein the memory further comprises instructions for causing the system to perform operations comprising: processing the analytical dataset using a random forest model to predict a respective value for each respective unclassified classifier attribute associated with the set of unclassified unique identifiers.

18. The system of claim 17, wherein the respective value for each respective unclassified classifier attribute is based on classified classifier attribute values in the analytical dataset.

19. The system of claim 17, wherein a separate random forest model is run for each respective unclassified classifier attribute.

20. The system of claim 11, wherein the memory further comprises instructions for causing the system to perform operations comprising:
generating a report including the unique identifier and the classifier attribute; and
causing, by the system, the report to display on the display screen coupled to the client computing device.

21. A tangible, non-transitory computer-readable medium storing instructions that, when executed by a computer system, cause the computer system to perform operations comprising:
receiving, over the Internet, a request for web page content from a client computing device of a user;
in response to the request for web page content, causing, by the computer system, the web page content to render on a display screen coupled to the client computing device;
analyzing, by the server computer system, metadata in the web page content to determine:
a unique identifier associated with the web page content; and
a classifier attribute associated with the unique identifier for classifying the web page content, wherein determining the classifier attribute for the unique identifier is based on a classifier attribute associated with a previously-classified unique identifier for other web page content; and
storing the unique identifier and the determined classifier attribute for the web page content in a database in communication with the computer system.
